(19) United States
(12) Patent Application Publication
(10) Pub. No.: US 2026/0210105 A1
(43) Pub. Date: Jul. 23, 2026

(54) METHOD FOR CONSTRUCTING BUILDING AND FORMWORK

(71) Applicant: Yamagata Chemical Co.,Ltd., Toyama-shi (JP)

(72) Inventor: Masaki NAGASHIMA, Toyama-shi (JP)

(21) Appl. No.: 19/541,400

(22) Filed: Feb. 17, 2026

Related U.S. Application Data
(63) Continuation of application No. PCT/JP2024/020781, filed on Jun. 6, 2024.

(30) Foreign Application Priority Data
Aug. 30, 2023 (JP) 2023-139972

(51) Int. Cl. E04B 1/32

(52) U.S. Cl. CPC E04B 1/3211

(57) ABSTRACT

To facilitate a method for constructing a building using a resin composition as a material for a structure, the method for constructing a building 11, comprises a formwork installation step of installing a formwork 10 that has flexible sheet materials 1 and 2 and is provided with a structure space that is defined by the flexible sheet materials 1 and 2, the structure space 6 being configured to form a shape corresponding to a structure 12 shape of the building 11 to be constructed when the structure space is expanded and a structure forming step of forming the structure 12 of the building 11 made of a foamed resin by foaming a resin composition 13 containing a foaming agent in the structure space 6 and curing the foamed resin composition 13 in the structure space 6 while the structure space 6 is in an expanded state.

### CROSS-REFERENCE TO RELATED APPLICATIONS

This application claims the benefit of priority and is a Continuation application of the prior International Patent Application No. PCT/JP2024/020781, with an international filing date of Jun. 6, 2024, which designated the United States, and is related to the Japanese Patent Application No. 2023-139972, filed Aug. 30, 2023, the entire disclosures of all applications are expressly incorporated by reference in their entirety herein.

### TECHNICAL FIELD

The present disclosure relates to a method and the like for constructing a building using a foamed resin as a structure material.

### BACKGROUND ART

Wood, stone, steel, concrete or reinforced concrete are generally used as building materials. On the other hand, Non-Patent Document 1 describes a method for constructing buildings using a polystyrene foam as a method for constructing buildings using a special material. In this construction method, building components made of a polystyrene foam are manufactured using molds.

### PRIOR ART TECHNICAL DOCUMENT

### Non-Patent Document

[Non-Patent Document 1] Wataru Sekine and four others, “Development of Dome House Using Polystyrene Foam: Part 1-Continuous Vibration Testing and Free Vibration Testing,” Vol.: 2011, Pages: 841-842, Jul. 20, 2011, Architectural Institute of Japan Proceedings B-1 Structures 1 (Architectural Institute of Japan Proceedings B-1 Structures 1: Loading, Reliability, Applied Mechanics, Structural Analysis, Basic Structures, Shells, Spatial Structures).

### DESCRIPTION OF THE DISCLOSURE

### Problem(s) to be Solved by the Disclosure

However, in the construction method for buildings described in Non-Patent Document 1, preparing a mold used to manufacture the polystyrene foam building components takes time. Furthermore, since the polystyrene foam building components are manufactured at a factory and are bulky, transporting them to a building site is not easy.

The present disclosure was made in light of these circumstances and aims to facilitate methods for constructing buildings using resin compositions as materials for structures.

### Means for Solving the Problems

To solve the above problems, the present disclosure provides a method for constructing a building, the method comprising a formwork installation step of installing a formwork that has a flexible sheet material and is provided with a structure space that is defined by the flexible sheet material, the structure space being configured to form a shape corresponding to a structure shape of the building to be constructed when the structure space is expanded; and
a structure forming step of forming the structure of the building made of a foamed resin by foaming a resin composition containing a foaming agent in the structure space and curing the foamed resin composition in the structure space while the structure space is in an expanded state, wherein the formwork comprises an inner membrane and an outer membrane as the flexible sheet material, and the structure space is provided between the inner membrane and the outer membrane, wherein, in the formwork installation step, the inner membrane of the formwork is put up by filling an inner space inside the inner membrane with gas, and wherein the structure forming step is performed with the inner membrane being put up.

### Effect of the Disclosure

According to the present disclosure, a building is constructed using a formwork comprising a flexible sheet material. This formwork is provided with a structure space that is defined by the sheet material, the structure space being configured to form a shape corresponding to a structure shape of the building to be constructed when the structure space is expanded. The structure space is provided between an inner membrane and an outer membrane. The inner membrane of the formwork is put up by filling an inner space inside the inner membrane with gas during the formwork installation step. The structure forming step is performed with the inner membrane being put up. During the structure forming step a structure of the building made of a foamed resin is formed by foaming a resin composition containing a foaming agent in the structure space and curing the resin composition foamed in the structure space with the structure space being expanded. Consequently, there is no need for time-consuming preparation of molds required in conventional methods. Furthermore, since the building made of a foamed resin is formed on-site, it is easy to transport. According to the present disclosure, it is possible to facilitate construction of buildings using a resin composition as a structural material.

### BRIEF DESCRIPTION OF THE DRAWINGS

FIG. 1 is a schematic diagram showing the exterior appearance of a building constructed using a method for constructing a building according to an embodiment.

FIG. 2 is a schematic diagram showing a cross-sectional configuration of a formwork used in the method for constructing a building according to the embodiment.

FIG. 3 is a schematic diagram showing a state at the completion of a foundation constructing step in the method for constructing a building according to the embodiment.

FIG. 4 is a schematic diagram showing a state at the completion of the temporary installation of the formwork during a formwork installation step in the method for constructing a building according to the embodiment.

FIG. 5 is a schematic diagram showing a state during the inner membrane of the formwork has been put up in the formwork installation step in the method for constructing a building according to the embodiment.

FIG. 6 is a schematic diagram showing a state during a resin injection step in the method for constructing a building according to the embodiment.

FIG. 7 is a schematic configuration diagram of a mixer system used in the resin injection step in the method for constructing a building according to the embodiment.

FIG. 8 is a schematic diagram showing a state during a foaming and curing step in the method for constructing a building according to the embodiment.

FIG. 9 is a schematic diagram showing a state at the completion of a finishing step in the method for constructing a building according to the embodiment.

FIG. 10 is a schematic diagram showing a state during the inner membrane of the formwork has been put up in the formwork installation step in the method for constructing a building according to the first modified example of the embodiment.

FIG. 11 is a schematic diagram showing a state immediately after the foaming and curing step in the method for constructing a building according to the first modified example of the embodiment.

FIG. 12 is a schematic diagram showing a state immediately after the foaming and curing step in a case where an intermediate membrane is provided adjacent to an indoor side surface of an outer membrane as a method for constructing a building according to the first modified example of the embodiment.

FIG. 13 is a schematic diagram showing a state that the inner membrane of the formwork has been put up during the formwork installation step in the method for constructing a building according to the second modified example of the embodiment.

FIG. 14 is a schematic diagram showing a state that the outer membrane has been installed to cover the inner membrane during the formwork installation step in the method for constructing a building method according to the second modified example of the embodiment.

FIG. 15 is a schematic diagram showing a state in which the inner membrane of the formwork has been put up in the formwork installation step in the method for constructing a building according to the third modified example of the embodiment.

FIG. 16 is a schematic diagram showing a state at the completion of temporary installation of the formwork during the formwork installation step in the method for constructing a building according to the fourth modified example of the embodiment.

FIG. 17 is a schematic diagram showing a state that the inner membrane of the formwork has been put up during the formwork installation step in the method for constructing a building according to the fourth modified example of the embodiment.

FIG. 18 is a schematic diagram showing a state immediately after the foaming and curing step in the method for constructing a building according to the fourth modified example of the embodiment.

FIG. 19 is a schematic diagram showing a state during the resin injection step in the method for constructing a building according to another modified example of the embodiment.

FIG. 20 is a schematic diagram showing a state at the completion of foundation constructing step in the method for constructing a building according to a reference embodiment.

FIG. 21 is a schematic diagram showing a state at the completion of the formwork installation step in the method for constructing a building according to the reference embodiment.

FIG. 22 is a schematic diagram showing a state at the completion of the resin injection step in the method for constructing a building according to the reference embodiment.

FIG. 23 is a schematic diagram showing a state during the foaming and curing step in the construction method for the building according to the reference embodiment.

FIG. 24 is a schematic diagram showing a state at the completion of the foaming and curing step in the method for constructing a building according to the reference embodiment.

FIG. 25 is a schematic diagram showing a state at the completion of the finishing step in the method for constructing a building according to the reference embodiment.

### MODES FOR CARRYING OUT THE DISCLOSURE

The embodiment of the present disclosure will now be described in detail with reference to the drawings. The following embodiment is one example of the present disclosure and is not intended to limit the disclosure, its applications or the scope of its uses.

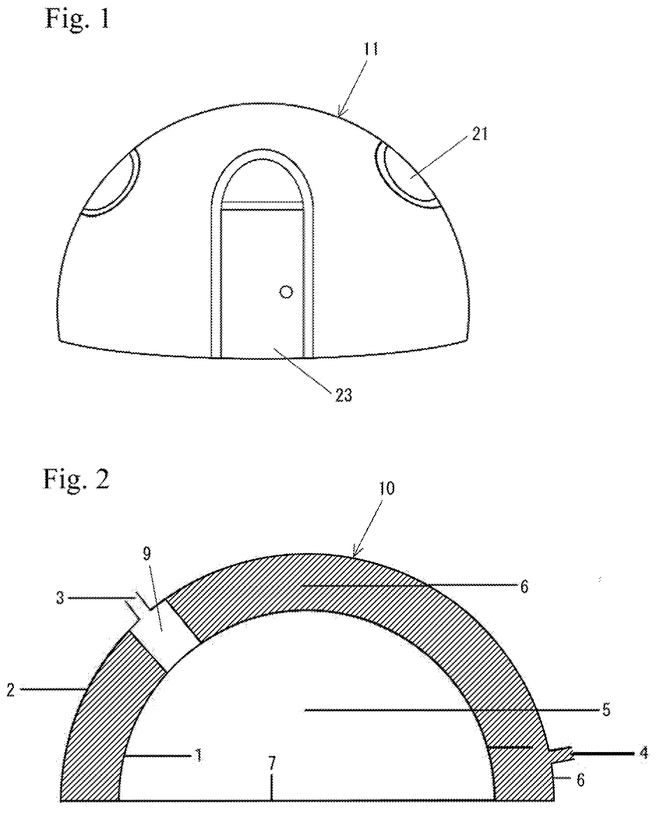

The present embodiment is a construction method (hereinafter referred to as “the present construction method”) for constructing a building 11 having a living space as a structure. The shape of the building 11 is dome-shaped as shown in FIG. 1. In the present construction method, a formwork (flexible formwork) 10 composed of flexible sheet materials 1, 2 and 7 is used. The formwork 10 is foldable, thus providing good transportability.

### 1. Formwork

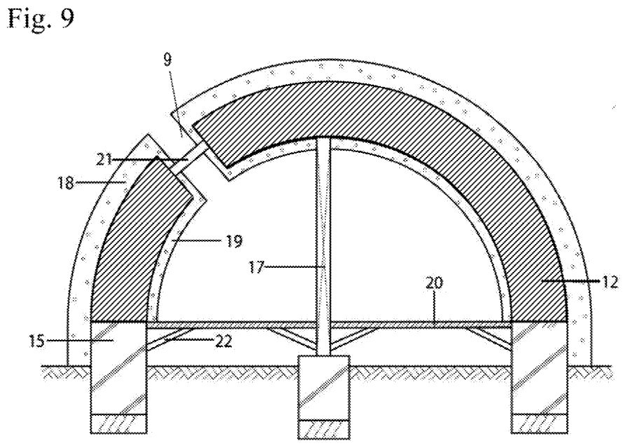

First, the formwork 10 will be described. The formwork 10, as shown in FIG. 2, comprises an inner membrane 1 and an outer membrane 2 as the flexible sheet materials 1 and 2. The formwork 10 is provided with a structure space 6 that is defined by sheet materials 1 and 2 and the structure space 6 assumes a shape corresponding to the shape of the structure 12 (see FIG. 9) of the building 11 to be constructed when the space 6 is expanded. The structure space 6 is provided between the inner membrane 1 and the outer membrane 2. The structure space 6 has a volume of 0.5 m³ or more when fully expanded, for example.

The formwork 10 is provided with an inner space 5 inside the inner membrane 1 as a gas-filling space 5 to be filled with gas such as air. The gas-filling space 5 is a sealed space. The gas-filling space 5 is defined together with the inner membrane 1 by a bottom sheet 7. The bottom sheet 7 is also composed of a flexible sheet material. The inner membrane 1 is connected to an outer periphery portion of the bottom sheet 7. When gas is filled into the gas-filling space 5, the inner membrane 1 assumes a dome-shape (substantially hemispherical shape).

The outer membrane 2 is a sheet material that has substantially the same shape as the inner membrane 1 but is one size larger. The outer membrane 2 is connected to the outer periphery portion of the bottom sheet 7 outside of a connecting portion of the bottom sheet 7 to the inner membrane 1. When the gas-filling space 5 and the structure space 6 are fully expanded, the outer membrane 2 assumes a dome shape as shown in FIG. 2 and faces the inner membrane 1 with a distance equivalent to the wall thickness of the structure 12. The structure space 6 is defined by the inner membrane 1, the outer membrane 2 and the bottom sheet 7.

Note that, in the present embodiment, for the bottom sheet 7, a flexible sheet material integrated with the inner membrane 1 and the outer membrane 2 is used, but a rigid plate material may also be used. In the former case, the bottom sheet 7 is joined to the inner membrane 1 and the outer membrane 2 in advance, for example, at a factory or the like. In the latter case, the bottom sheet 7 may be joined to the inner membrane 1 and the outer membrane 2 in advance at a factory or the like, or may be joined to the inner membrane 1 and the outer membrane 2 at a construction site of the building 11.

The formwork 10 is provided with a gas inlet 3 for injecting gas to inflate the gas-filling space 5, and a resin inlet 4 for injecting a resin composition containing a foaming agent (hereinafter referred to as the “structure resin material”) 13 into the structure space 6.

The gas inlet 3 may be provided at a location that becomes an opening portion 9 (an opening portion 9 where a window glass 21 or a door 23, or the like is installed) communicating between an outside space and the inner space 5 in the completed structure 12. In this case, the gas inlet 3 is provided so as to penetrate the inner membrane 1 and the outer membrane 2. Note that the gas inlet 3 may be provided at another location (for example, the bottom sheet 7).

In the formwork 10, the resin inlet 4 is provided, for example, in its bottom side. The number of the resin inlets 4 in the formwork 10 may be one or two or more. For example, when the size of the building 10 is large, by providing a plurality of the resin inlets 4, the structure resin material 13 can be easily spread throughout the structure space 6.

In areas of the sheet materials 1 and 2 of the formwork that define the structure space 6 (the areas facing the structure space 6), ventilating portions are provided to allow air of the structure space 6 to escape into a space adjacent to the structure space 6 (either the space outside of the outer membrane 2 or the inner space 5) that the sheet materials 1 and 2 sandwich, as the structure resin material 13 foams.

In a case where the sheet materials 1 and 2 (the inner membrane 1 and the outer membrane 2) are breathable mesh sheets (such as cloth), the ventilating portions are gaps between threads forming the mesh over the entire surface of the mesh sheets (mesh gaps (or weaves interstices). In the mesh sheet, numerous gaps (ventilating portions) by the mesh are formed. Each gap in the mesh is formed to a size that, for example, allows air to pass through, but prevents the structure resin material 13 from passing through. Note that the sheet materials 1 and 2 may also be breathable nonwoven sheets. In this case, the ventilating portions are gaps between entangled fibers over the entire surface of the nonwoven sheet. In the nonwoven sheet, numerous gaps (ventilating portions) are formed by the entangled fibers. Each gap formed by the fibers is formed to a size that, for example, allows air to pass through, but prevents the structural resin material 13 from passing through. Further, the ventilating portions may also be one or more small holes provided in the sheet materials 1 and 2. In this case, the small holes are formed to a size that allows air to pass through, but prevents the structure resin material 13 from passing through, or to a size that allows only a slight amount of the structure resin material 13 to pass through.

A sheet material having ventilating portions (such as a breathable mesh sheet, a breathable nonwoven sheet, a sheet having one or more small holes and the like) is used for one or both of the inner membrane 1 and the outer membrane 2. The nonwoven sheet is a sheet in which fibers are entangled such as a nonwoven fabric or paper. This suppresses formation of voids (portions not filled with the resin) during foaming and curing of the structure resin material 13.

For example, a sheet material having ventilating portions may be used for the outer membrane 2 of the inner membrane 1 and the outer membrane 2. In this case, a breathable sheet material is not used for the inner membrane 1. A sheet material having no ventilating portion (a non-breathable sheet material) may be used for the inner membrane 1. Here, Japanese Unexamined Patent Application Publication No. 51-51129 describes a method for constructing a structure in which an inner membrane body is supported via spacers by an outer membrane body that is formed into a dome-shape and made self-standing by pressurizing the air inside of the outer membrane body. In this case, recesses are formed in the position of each spacer of the inner surface of the structure. In contrast, in this example of the present embodiment, a sheet material having ventilating portions is used for the outer membrane 2 to let out air from the structure space 6 to the outside to thereby suppress formation of voids and a sheet material having no ventilating portion is used for the inner membrane 1, whereby it becomes easy to maintain the inner membrane 1 to a constant shape by the pressure to the inner membrane from the inner space 5. Further, since the inner membrane 1 is supported by the pressure from the inner space 5, the aforementioned spacers are unnecessary, making it possible to form the structure 12 having a uniformly smooth inner surface.

### 2. Method for Constructing Buildings

Next, the present construction method will be described. The present construction method comprises a foundation constructing step, a formwork installation step, a resin injection step and a foaming and curing step, performed in this order. The resin injection step and the foaming and curing step constitute the structure forming step.

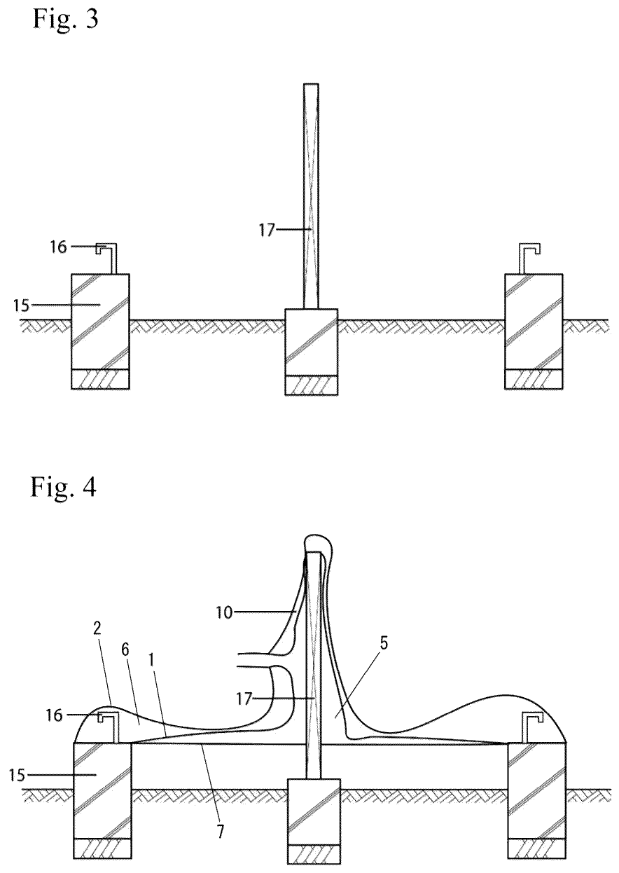

The foundation constructing step is a step for constructing a foundation 15 based on a planar shape of the structure 12 to be constructed. As the materials for the foundation 15, for example, concrete or reinforced concrete may be used. As shown in FIG. 3, the foundation 15 is constructed such that at least its lower portion is embedded in the ground. While the upper surface of the foundation 15 is located above the ground in FIG. 3, it may also be located below the ground. The foundation 15 has a wall-like portion along an outer perimeter of the structure 12 to be constructed when viewed in plan.

Note that a foamed resin may also be used as the material for the foundation 15. In this case, like the formwork 10, a flexible formwork (not shown) may be used. This formwork comprises a flexible sheet material and is provided with a structure space that is defined by the sheet material and, when expanded, the structure space assumes a shape corresponding to the shape of the foundation 15 to be constructed.

The foundation 15 is integrated with a connecting member 16 as a component for connecting the foundation 15 and the structure 12. The connecting member 16 is partially embedded in the foundation 15, with the remainder exposed from the foundation 15. The exposed portion of the connecting member 16 is positioned in a space occupied by a lower portion of the structure 12. In FIG. 3, the connecting member 16 protrudes from the upper surface of the foundation 15.

Further, the foundation 15 is integrated with a pillar (column member) 17 as a member for supporting the formwork 10 from below. The pillar 17 has its lower end embedded in the foundation 15, with the remainder protruding upward from the foundation 15. In FIG. 3, the upper end of the pillar 17 is provided to support the top of the formwork 10. Note that the pillar 17 may be omitted.

The formwork installation step is a step of installing the formwork 10 to match the foundation 15. In the formwork installation step of the present embodiment, after temporary installation of the formwork 10, the inner membrane 1 of the formwork 10 is put up by filling the gas-filling space 5 with gas. The term “put up” means to shape all or a part of the formwork 10 to correspond to the shape of the structure 12.

The temporary installation of the formwork 10, as shown in FIG. 4, is an operation of installing the formwork 10 while the gas-filling space 5 and the structure space 6 are in a shrunk state (a state where there is almost no air in the gas-filling space 5 and the structure space 6). The formwork 10 is temporarily installed to cover the pillar 17 from above. The formwork 10 is temporarily installed such that the lower edge of inner membrane 1 is positioned near the upper edge of an inner peripheral surface of the foundation the 15, and the lower edge of the outer membrane 2 is positioned near the upper edge of an outer peripheral surface of the foundation 15. The outer peripheral portion of the bottom sheet 7 is placed on the wall-like portion of the foundation 15. The bottom sheet 7 is provided to seal the inner space inside the wall-like portion of the foundation 15.

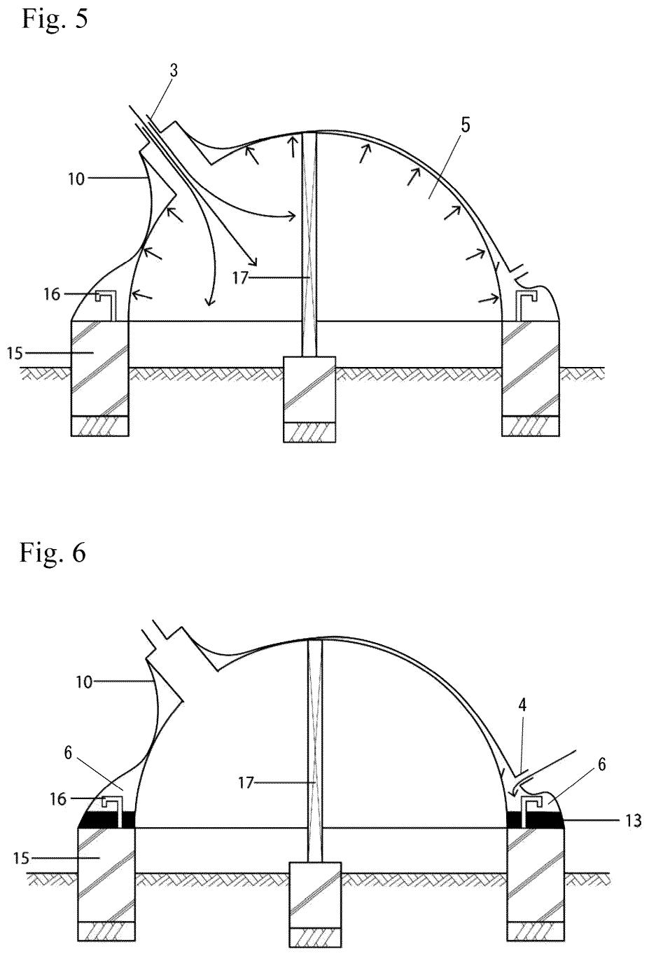

The inner membrane 1 is put up, as shown in FIG. 5, by filling gas into the gas-filling space 5 through the gas inlet 3 in the formwork 10. For example, a hose extending from an outlet of an air pump (not shown) is connected to the gas inlet 3, and gas is discharged from the air pump, thereby filling gas into the gas-filling space 5 through the gas inlet 3.

The resin injection step is a step of injecting the structure resin material 13 into the structure space 6 through the resin inlet 4 in the formwork 10. As shown in FIG. 6, the structure resin material 13 is injected into the structure space 6 from a state where there is almost no gas in the structure space 6, whereby the formation of voids is suppressed in the structure 12 of the building 11.

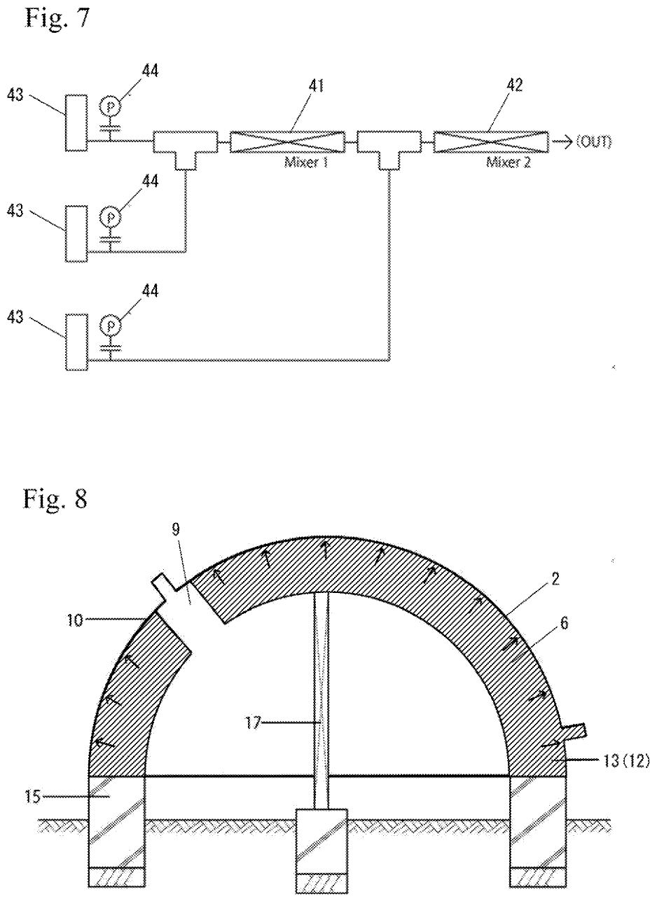

For example, in a case of obtaining the structure resin material 13 by blending different multiple raw resins at the construction site of the building 11, mixers 41 and 42 (for example, shown in FIG. 7) are installed at the construction site of the building 11, and an outlet of the mixer 42 is connected to the resin inlet 4. Although FIG. 7 shows the plurality of mixers 41 and 42 are used, only one mixer 41 or 42 may be used. Multiple raw resins from multiple containers 43, each containing a raw resin, are supplied to the mixers 41 and 42 using a pump 44, whereby the structure resin material 13 blended with multiple raw resins is then supplied from the resin inlet 4 into the structure space 6.

The foaming and curing step is a step of forming the structure 12 of the building 11 made of foamed resin by: expanding the structure space 6 by foaming the structure resin material 13 in the structure space 6; and curing the structure resin material 13 foamed in the structure space 6 while the structure space 6 is in an expanded state. In the foaming and curing step, the foaming of the structure resin material 13 causes the structure space 6 to expand, as shown in FIG. 8, allowing the outer membrane 2 to be put up and formed into a dome-shape. Then the structure resin material 13 then gradually cures, and after a predetermined time has elapsed, the structure 12 of the building 11 is completed.

After the completion of the structure 12, the finishing step is performed. In the finishing step, after the inner membrane 1 and the outer membrane 2 are removed, exterior work, interior work, floor installation work, window installation work and the like may be performed.

In the exterior work, an outermost layer 18 is provided by plastering work and the like to cover the outer surface of the structure 12. In the interior work, an innermost layer 19 is provided by plastering work and the like to cover the inner surface of the structure 12. In the floor installation work, a floorboard 20 is provided to be supported by the foundation 15 and the like. In the window installation work, a window glass 21 is provided at a location of the opening portion 9 provided with the inlet 3 and the like. FIG. 9 shows a state which these works are completed. In FIG. 9, a brace 22 is provided to reinforce the building 11.

In the present embodiment, the opening portion 9 is provided in the formwork 10 to provide the opening portion 9 in the structure 12 to which a door 23, a window 21 and the like is installed. In this case, a plastic or metal frame member (a frame member for the door 23 or the window 21) may be pre-attached in the structure space 6 of the formwork 10 to surround the opening portion 9. Note that the opening portion 9 may be made by cutting the structure 12 after the foaming and curing of the structure resin material 13.

Furthermore, to enhance the strength of the completed building 11, during the formwork installation step, in addition to the pillar 17, a reinforcing member such as a beam may be pre-attached to match the formwork 10, or a foam may be processed and installed after being foamed.

### 3. Materials and the Like

### <3-1. Materials for Formwork>

As the materials for the sheets 1, 2 and 7 in the formwork 10, one type may be used from a group of an organic membrane using a thermoplastic resin such as polyvinyl chloride, a polystyrene resin including polystyrene, a polyolefin resin such as polypropylene or polyethylene, a polyacetal, a polyester such as polyethylene terephthalate or polybutylene terephthalate, a (meth)acrylic resin, an AS resin, or an ABS resin; a metal membrane using aluminum or the like; and a cloth made of organic fibers (natural fibers, synthetic fibers, carbon fibers, etc.), inorganic fibers, or metal fibers, or two or more types selected from this group may be used. In addition, a cloth not listed in this paragraph or a sheet other than cloth may also be used as the materials for the sheet materials 1, 2 and 7.

The sheet materials 1, 2 and 7 may be composed of one or more of an organic membrane having a tensile modulus of 50 GPa; a metal membrane having a tensile modulus of 150 GPa or less; and a cloth. The tensile modulus of the aforementioned organic membrane is not limited so long as it does not impair the effects of the present embodiment; for example, it may be 50 GPa or less, preferably 30 GPa or less, and more preferably 20 GPa or less. Further, the tensile elastic modulus of the aforementioned metal membrane is not limited so long as it does not impair the effects of the present embodiment. For example, it may be 150 GPa or less, preferably 100 GPa or less, and more preferably 80 GPa or less. In addition, the elastic modulus of the aforementioned cloth is not limited so long as it does not impair the effects of the present embodiment.

Further, the thickness of the sheet materials 1, 2 and 7 used in the formwork 10 is not limited so long as it does not impair the effects of the present embodiment. For example, it may be 10 mm or less, preferably 8 mm or less, and more preferably 5 mm or less.

### <3-2. Resin Composition>

For the foamed resin (foam) constituting the structure 12 of the architecture 11 (such as a building) 11, at least one type or more of resins selected from a group consisting of a urethane resin having an isocyanate group; a vinyl resin including a urea resin, a (meth)acrylic resin and a styrene resin; an epoxy resin; a phenol resin; an ester resin; and an amide resin may be used, and two or more of the above resins may be mixed. The foamed resin is obtained by foaming and curing a resin composition or by vaporizing a solvent that acts as a foaming agent. The resin composition (structure resin material) that serves as the material for the foamed resin contains a monomer compound (A), a curing agent, a catalyst and a foaming agent and preferably also contains a foam stabilizer and a flame retardant. In the case of vinyl resins and the like including (meth)acrylic resins and styrene resins, a radical initiator (B) that generates radicals by heat or irradiation with active light rays is used instead of the curing agent.

Each of the resins may be one or more types of resins, and there is no problem that multiple resin systems may be mixed. Further, having multiple resin system functional groups attached to a single compound enables construction of a complex network system.

### <3-3. Raw Materials for Resin Compositions>

### <<3-3-1: Raw Materials for Urea and Urethane Resin Compositions>>

### <<<3-3-1-1: Monomer Compound (A): Polyisocyanate Compound>>>

The polyisocyanate compound (A) used in the resin composition (structure resin material) of the present embodiment is not particularly limited so long as it does not impair the effects of the present embodiment. Examples of the polyisocyanate compound (A) include monomer-type polyisocyanates and polymer-type polyisocyanates. The monomer-type polyisocyanate is a compound having multiple isocyanate groups at terminal ends of a monomer structure. The polymer-type polyisocyanate is a compound having multiple isocyanate groups at terminal ends of a polymer structure. These polyisocyanate compounds (A) may be used alone or in combination with one another.

The monomeric polyisocyanates can include, for example, aromatic types such as polymeric MDI and xylylene diisocyanate (XDI), and aliphatic types such as isophorone diisocyanate, and may also include their modified forms, derivatives and the like. Examples of such modified forms and derivatives include, for example, isocyanurate compounds of diisocyanate compounds, adduct compounds of diisocyanate compounds, bullet compounds of diisocyanate compounds, allophane compounds of diisocyanate compounds and carbodiimide-modified compounds of diisocyanate compounds. Note that these polyisocyanate compounds may be used alone or in combination.

The polymeric polyisocyanate compounds include those prepolymerized by reacting an excessive amount of apolyisocyanate compound with an active hydrogen compound having two or more active hydrogen groups, such as a polyol compound or a polyamine compound.

The NCO % of the polyisocyanate compound (A) is not limited so long as it does not impair the effects of the present embodiment. For example, it can be 5 to 40%, preferably 10 to 35% and more preferably 15 to 35%. When the NCO % of the polyisocyanate compound (A) is increased, a foam with lower thermal conductivity and improved resistance to aging under humid heat conditions can be obtained.

### <<<3-3-1-2: Hardeners and Catalysts: Polyamine Compounds, Trimeric Catalysts (B)>>>

A polyol compound reacts with an isocyanate to a form urethane bond. A polyamine compound reacts with an isocyanate to form a urea bond. A trimeric catalyst reacts with an isocyanate to form an isocyanate ring.

The polyol compound is not particularly limited so long as it does not impair the effects of the present embodiment. The polyol compound (B) includes, for example, a polyester polyol, a polyether polyol and the like. A Some polyester polyols are obtained by a condensation reaction of a polyhydric alcohol with a polycarboxylic acids. A polyhydric alcohol includes, for example, ethylene glycol, propylene glycol, butanediol, butylene glycol, glycerin, trimethylolpropane and like, the Examples of the polycarboxylic acid include, for example, glutaric acid, adipic acid, maleic acid, phthalic acid, terephthalic acid, isophthalic acid and the like. These may be used alone or in combination. Further, polyester polyols obtained by ring-opening polymerization of caprolactone, methylvalerolactone and the like may be raised.

Examples of the polyether polyol include, for example, those obtained by addition polymerization of an oxide such as ethylene oxide with a polyhydric alcohol such as ethylene glycol or glycerol. These may be used alone or in combination.

The polyamine compound is not particularly limited so long as they do not impair the effects of the present embodiment. Examples of the polyamine compound (B) include, for example, aliphatic polyamines such as triethylenetetramine, aromatic polyamines such as m-phenylenediamine and alicyclic polyamines such as isophoronediamine. Examples of commercially available products include Erasmer 250P and Erasmer 1000P from Kumiai Chemical Industry Co., Ltd., and Ethacure 420 from Albemarle Corporation. These may be used alone or in combination.

Examples of the trimerization catalyst include, for example, metal oxides such as lithium oxide, sodium oxide, and potassium oxide; alkoxides such as sodium methoxide, organometallic salts such as potassium acetate and potassium octanoate; tertiary amines such as 2,4,6-tris (dimethylaminomethyl) phenol and N,N′,N″-tris (dimethylaminopropyl) hexahydrotriazine; ethyleneimine derivatives; chelates such as alkali metals and aluminum; quaternary ammonium salts; diazabicycloundecene (DBU) and the like. These may be used alone or in combination. Among these, it is more preferable to use tertiary amines, organometallic salts, and diazabicycloundecene, and it is more preferable to use tertiary amines and diazabicycloundecene. This allows for obtaining a foam with excellent adhesion during construction.

### <<3-3-2: Foaming Agent>>

The foaming agent according to the present embodiment is not particularly limited so long as the effects of the present embodiment are not impaired. Examples of the foaming agents include, for example, water, hydrocarbons (preferably C₄ to C₆), hydrofluoroolefins, carbon dioxide gas and nitrogen gas. Specifically, examples include carbon dioxide generated by the reaction of isocyanate with water, cyclopentane, HFO (1336mzz), HFO (1233zd), carbon dioxide, 2-methylpropene and the like. These may be used alone or in combination.

### <<3-3-3: Foam Stabilizer>>

The foam stabilizer to the present embodiment is not particularly limited so long as the effects of the present embodiment are not impaired. Examples of the foam stabilizers include, for example, polymers, silicone compounds, nonionic surfactants and the like. These can be used alone or in combination.

### <<3-3-4: Flame Retardant>>

The resin composition (structure resin material) according to the present embodiment may contain a flame retardant. The flame retardant is not particularly limited so long as it does not impair the effects of the present embodiment, but examples thereof include, for example, red phosphorus, phosphate esters, phosphate-containing flame retardants, bromine-containing flame retardants, boron-containing flame retardants, antimony-containing flame retardants and metal hydroxides. These may be used alone or in combination. When the urea resin composition of the present embodiment contains a flame retardant, it is possible to obtain a polyurea foam having excellent flame retardancy and shape retention during combustion, suppressing aging degradation under a humid heat environment, and exhibiting excellent adhesion to substrates during coating. Further, other flame retardants than those listed above may be included.

### <<3-3-5: Other Additives>>

The resin composition (structure resin material) according to the present embodiment may further contain other additives in addition to the above additives, provided they do not impair the effects of the present embodiment. As the other additives, additives known in the art may be used such as foaming catalysts, balanced catalysts, antioxidants, ultraviolet absorbers, antibacterial agents, insect repellents, termite repellents and dispersants.

### <3-4. Characteristics of Foam>

### <<3-4-1: Density>>

The density of the foam is not particularly limited so long as it does not impair the effects of the present embodiment, but it can be 10 to 500 kg/m³, preferably 20 to 400 kg/m³, more preferably 25 to 300 kg/m³, and still more preferably 30 to 200 kg/m³. When the density of the foam falls within this range, such a foam can be obtained that provides sufficient construction workability for the structure 12 and sufficient strength of the structure 12. The density of the foam density is measured according to JIS K7222:2005 “Foamed Plastics and Rubber-Determination of Apparent Density”.

### <<3-4-2: Foaming Ratio>>

The expansion ratio is preferably 3 or more, more preferably 4 or more, and still more preferably 5 or more. The expansion ratio is calculated by the following Equation 1.

Expansion Ratio=Density before foaming/Apparent density of foam [Equation 1]

### <<3-4-3: Compressive Modulus>>

The compressive modulus of the polyurea foam may be, for example, 1 MPa or more, preferably 2 MPa or more, more preferably 3 MPa or more, and still more preferably 4 MPa or more. When the compressive modulus falls within this range, a polyurea foam having the effects of the present embodiment can be obtained. The compressive modulus is measured by the method described in JIS K7220:2006 “Rigid Foamed Plastics-Determination of Compressive Properties”.

### <3-5. Method for Manufacturing Foam>

The resin composition (structure resin material) of the present embodiment is composed by blending multiple mixed liquids with different components from each other. The structure resin material is prepared by pre-mixing monomer compound (A), monomer compound ((A), curing agents or catalysts, radical initiators (B), forming agents, foam stabilizers, red phosphorus, other flame retardants and other additives. Known methods can be used for mixing the resin composition. Specifically, the resin compositions shown below were mixed using appropriate methods.

Further, the viscosity of each mixture liquid is not limited so long as it does not impair the effect of the present embodiment. For example, 50,000 mPa·sec or less is preferable, 40,000 mPa·sec or less is more preferable, 30,000 mPa·sec or less is further preferable, and 20,000 mPa·sec or less is still more preferable.

### <<3-5-1: Foam Manufacturing Using Urea and Urethane Resin Composition>>

The raw materials other than the isocyanate compound (A) are mixed in a mixer (for example, a stirrer equipped with a propeller-type stirring blade) to prepare polyol/polyamine mixture. Subsequently, the isocyanate compound (A) and the polyol/polyamine mixture liquid are respectively cooled to a predetermined temperature (for example, 10° C.). Thereafter, the isocyanate (A) and the polyol/polyamine mixture are mixed by a mixer (for example, stirred at 2000 rpm for 5 seconds using the aforementioned mixer), foamed and cured to obtain a polyurethane or urea foam. Note that when used in the construction method (process) of the present embodiment, a mixture liquid (I) containing the isocyanate compound (A) as a main agent and a mixture liquid (II) containing the other raw materials are heated (from 10° C. to 80° C.), supplied respectively by a pump and the like, mixed by the mixers 41 and 42 and the like and filled into the formwork 10 to obtain the foam. For example, it can be handled as a two-component system liquid comprising a polyol/polyamine mixture liquid prepared by pre-mixing raw materials other than the polyisocyanate and the polyisocyanate compound (A). Note that flame retardants, foam stabilizers, foaming agents, dispersants, and other additives that do not react with the polyisocyanate compound (A) can be mixed with the polyisocyanate compound (A) and handled as a system liquid. Further, depending on the compatibility of the respective compounds, three or more liquids may also be used.

### 4. Effect of the Present Embodiment and the Like

In the present embodiment, the building 11 is constructed using the formwork 10 having the flexible sheet materials 1, 2 and 7. The formwork 10 is provided with the structure space 6 that is defined by the sheet materials 1, 2 and 7 and, when expanded, assumes a shape corresponding to the shape of the structure 12 of the building 11 to be constructed. The structure space 6 is provided between the inner membrane 1 and the outer membrane 2. During the formwork installation step, gas is filled into the inner space 5 inside the inner membrane 1 to build the inner membrane 1 of the formwork 10. The structure formation step is then performed with the inner membrane 1 being put up. During the structure forming step, the structure space 6 is expanded by foaming the resin composition 13 containing a foaming agent in the structure space 6. The resin composition 13 foamed in the structure space 6 is then cured to form the structure 12 of the building 11 made of the foamed resin. Therefore, there is no need for time-consuming preparation of molds as in conventional methods. Further since the building 11 made of the foamed resin is formed on-site, transportation is unnecessary. Further, the flexible sheet materials 1, 2, and 7 of the formwork 10 can be folded, making it easy to transport. According to the present embodiment, the construction of buildings using a resin composition as the structure material can be facilitated.

Note that in the present embodiment, since the pillar 17 is provided to support the inner membrane 1 from the indoor side, deformation of the inner membrane 1 due to the weight of the resin composition 13 is suppressed, and a change in the volume of the structure space 6 before and after foaming is also suppressed. Note that in the present embodiment, the pillar 17 is installed before the formwork installation step, but it may also be installed after the formwork installation step. In this case, a relatively large opening (for example, an opening for installing a door as shown in FIG. 1) is provided in the formwork 10. Through this opening, the pillar 17 is transported into the gas-filling space 5 after the formwork installation step, and the pillar 17 is installed.

In the present embodiment, during the structure formation step, the structure space 6 is expanded by starting to foam the structure resin material 13 when the structure space 6 is in a contracted state. According to the present embodiment, since the amount of gas in the structure space 6 is low at the timing when foaming of the structure resin material 13 is started, formation of voids during the foaming and curing of the resin material 13 is suppressed.

### 5. First Modified Example of the Present Embodiment

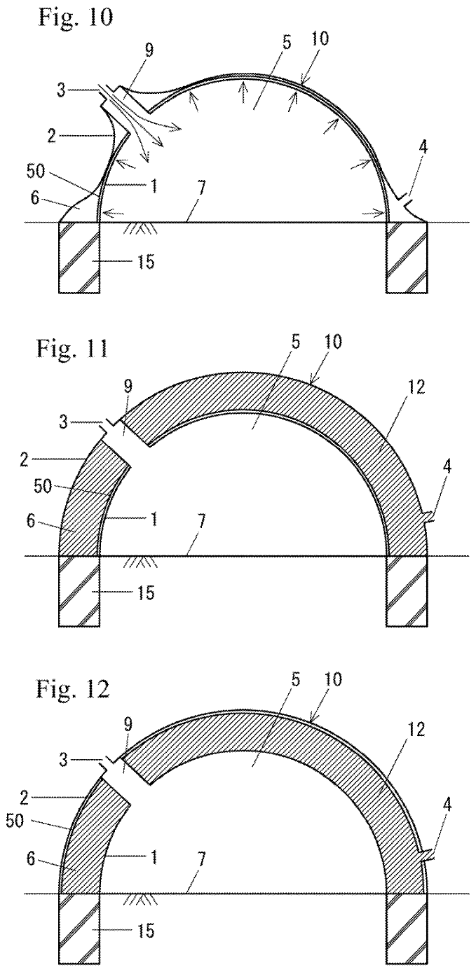

In this modified example, an intermediate membrane 50 is provided between the inner membrane 1 and the outer membrane 2. As shown in FIGS. 10 and 11, the intermediate membrane 50 is provided adjacent to the outer surface of the inner membrane 1. The intermediate membrane 50 is superimposed on the inner membrane 1. In this case, the structure space 6 is provided between the intermediate membrane 50 and the outer membrane 2 in the space between the inner membrane 1 and the outer membrane 2. The intermediate membrane 50 defines the structure space 6 from the indoor side, and the inner membrane 1 supports the intermediate membrane 50 from the indoor side.

In the formwork installation step, as in the above embodiment, after the temporary installation of the formwork 10, gas is filled into the gas-filling space 5 through the gas inlet 3, thereby building the inner membrane 1 of the formwork 10. FIG. 10 shows a state in which the inner membrane 1 is put up. The structure formation step is then performed with the inner membrane 1 being put up.

In the structure formation step, as in the above embodiment, a resin injection step of injecting the structure resin material 13 into the structure space 6 through the resin inlet 4 and a foaming and curing step of foaming the structure resin material 13 in the structure space 6 to expand the structure space 6 and curing the foamed structure resin material 13 are performed in this order. The structure resin material 13 is cured during the foaming and curing step, whereby the structure 12 of the building 11 composed of the foamed resin is formed. FIG. 11 shows a state immediately after the foaming and curing step.

Here, if the intermediate membrane 50 is not provided, it is necessary to decide the material and the like of the inner membrane 1 defining the structure 12 from the indoor side, taking into the condition that air does not readily leak when the inner space 5 is inflated. In contrast, in this modified example with the intermediate membrane 50 provided, the intermediate membrane 50 defining the structure 12 from the indoor side, it is not necessary to decide the material and the like taking into the above condition and the like, since the inner membrane 1 is present. According to this modified example, the degree of freedom in selecting the sheet material defining the structure 12 from the indoor side is enhanced.

In this modified example, for the intermediate membrane 50, a sheet material different from the material of the inner membrane 1 and of the same material as the outer membrane 2 may be used. For example, a breathable sheet material with high tensile strength (for example, a mesh sheet) may be used for the outer membrane 2 and the intermediate membrane 50. In this case, when performing the finishing step, the outer membrane 2 and the intermediate membrane 50 may be left in place without being removed. That is, the outer membrane 2 may be embedded inside the outermost layer 18, and the intermediate membrane 50 may be embedded inside the innermost layer 19 (not shown). Thereby, the surface strength of the outer and inner walls of the structure 12 may be enhanced. Note that in this case, the inner membrane 1 (for example, a non-breathable sheet material) may be removed after the foaming and curing step and before the finishing step, or it may be left in place together with the intermediate membrane 50.

The intermediate membrane 50 may be provided adjacent to the indoor side surface of the outer membrane 2 as shown in FIG. 12. The intermediate membrane 50 is superimposed on the outer membrane 2. In this case, the structure space 6 is provided between the inner membrane 1 and the intermediate membrane 50. The intermediate membrane 50 defines the structure space 6 from the outdoor side, and the outer membrane 2 supports the intermediate membrane 50 from the outdoor side. In this case, the sheet material defining the structure 12 from the outdoor side is not limited to a sheet material suitable for the outer membrane 2, enhancing the degree of freedom in selectin the sheet material defining the structure 12 from the outdoor side.

Note that the number of the intermediate membranes 50 is not limited to one, but may be two or more intermediate membranes provided. For example, a first intermediate membrane 50 adjacent to the outdoor side surface of the inner membrane 1 and a second intermediate membrane 50 adjacent to the indoor side surface of the outer membrane 2 may be provided simultaneously.

### 6. Second Modified Example of the Present Embodiment

In this modified example, the inner membrane 1 and the outer membrane 2 are separate bodies.

In the formwork installation step of this modified example, the following construction procedures may be adopted, for example. However, the formwork installation step is not limited to these construction procedures.
Construction Procedure 1: Temporary installation of the inner membrane 1, building of the inner membrane 1, installation of the outer membrane 2
Construction Procedure 2: Temporary installation of the inner membrane 1, installation of the outer membrane 2, building of the inner membrane 1
Construction Procedure 3: Temporary installation of the outer membrane 2, building of the outer membrane 2, temporary installation of the inner membrane 1, building of the inner membrane 1.

Note that “temporary installation” of the inner membrane 1 refers to installing it in a shrunk state without inflating it. For the outer membrane 2, “temporary installation” refers to installing it in a shrunk state only when building is performed (Construction Procedure 3).

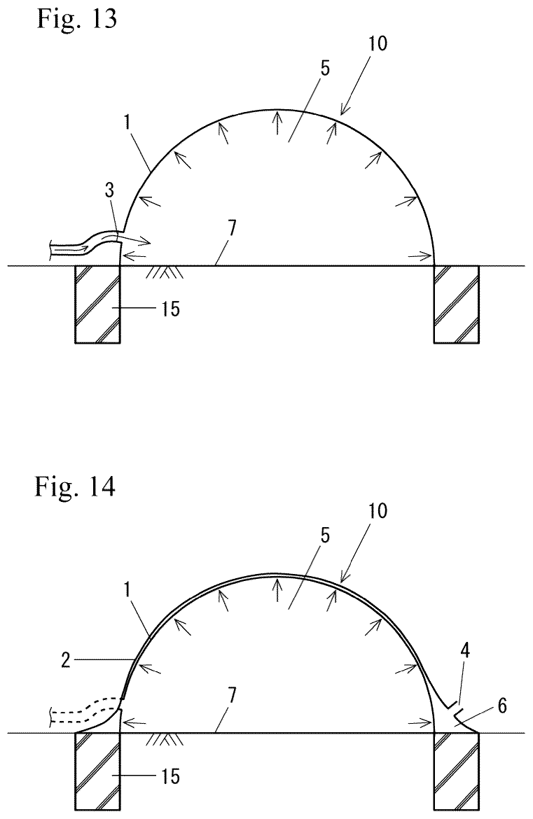

In the case of the Construction Procedure 1, the inner membrane 1 is temporarily installed at the planned installation location of the structure 12 with the gas-filling space 5 in a shrunk state. The inner membrane 1 is fixed to the foundation 15. Then, the inner membrane 1 is put up by filling gas into the gas-filling space 5. FIG. 13 shows the state after the inner membrane 1 has been put up. With the inner membrane 1 being put up, the outer membrane 2 is then installed to cover the inner membrane 1. The outer membrane 2 is fixed to the foundation 15. FIG. 14 shows the state that the outer membrane 2 is installed to cover the inner membrane 1. In this state, the gas-filling space 5 is inflated, but the structure space 6 is in a shrunk state (a state that there is substantially no air in the structure space 6).

In the case of the Construction Procedure 2, the inner membrane 1 is temporarily installed at the planned installation location of the structure 12 with the gas-filling space 5 in a shrunk state. The outer membrane 2 is then installed to cover the inner membrane 1 in a shrunk state from above. The inner membrane 1 and the outer membrane 2 are respectively fixed to the foundation 15. The inner membrane 1 is then put up by filling the gas-filling space 5 with gas. This state is the same as the state shown in FIG. 14.

In the case of the Construction Procedure 3, the outer membrane 2 is temporarily installed at the planned installation location of the structure 12 with the gas-filled space 5 in a shrunk state. By filing gas into the inner space inside the outer membrane 2, the outer membrane 2 is inflated into a dome-shape and to be in a put-up state. Next, the inner membrane 1 is temporarily installed in a shrunk state inside of the outer membrane 2. Then, by filling gas into the gas-filling space 5, the inner membrane 1 is put up. In this case, if a breathable mesh sheet is used for the outer membrane 2, air from the structure space 6 escapes through the ventilating portion of the outer membrane 2.

In any of the construction procedures, after the formwork installation step, the resin injection step is performed, injecting the structure resin material 13 into the structure space 6 through the resin inlet 4. Next, the foaming and curing step is performed wherein the structure resin material 13 is foamed in the structure space 6 to expand the structure space 6 and cure the structure resin material 13 foamed in the structure space 6 with the structure space 6 being expanded. Thereby, the structure 12 of the building 11 is completed.

Note that in the Construction Procedure 1, work for electricity, water and the like (installation work for piping and the like) are performed without the outer membrane 2 in the space occupied by the structure 12 after the inner membrane 1 is put up, but before the outer membrane 2 is installed. In the Construction Procedure 3, works for electricity, water and the like are performed without the inner membrane 1 in the space occupied by the structure 12 after building the outer membrane 2, but before installing the inner membrane 1. Thereby, the execution of the works is facilitated.

The intermediate membrane 50 may be provided as described in the first modified example above. In this case, the outer membrane 2 is formed separately from the inner membrane 1 and the intermediate membrane 50. Note that the inner membrane 1 and the intermediate membrane 50 may be formed integrally or separately.

### 7. Third Modified Example of the Present Embodiment

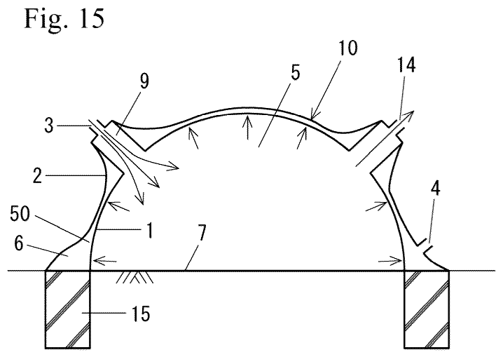

In this modified example, as shown in FIG. 15, a gas outlet 14 is provided in addition to the gas inlet 3 in the formwork 10 of the above embodiment. In this case, with the inner membrane 1 of the formwork 10 being put up, the gas-filling space 5 does not become a sealed space, and gas is continuously supplied from the gas inlet 3 into the gas-filling space 5 to maintain the inner membrane 1 in an expanded state. In this state, gas overflowing from the gas-filling space 5 is discharged through the gas outlet 14. The structure forming step is then performed in this state.

Here, in the case of providing in the formwork 10 only the gas inlet 3 from the gas inlet 3 and gas outlet 14, the gas inlet 3 is closed to stop gas supply to the inner space 5, for example, to maintain the pressure in the inner space 5 after the inner membrane 1 is put up. However, in the case of constructing a structure of such a size that it includes, for example, a living space, the foaming and curing of the resin composition 13 takes time. Consequently, there is a risk that gas may escape through gaps or a small amount of gas permeate through the inner membrane, causing the pressure in the inner space 5 to decrease. In this case, it is difficult to stabilize the shape of the final structure 12 to be constructed.

In contrast, in this modified example, with the inner membrane 1 being put up, gas is continuously supplied from the gas inlet 3 into the inner space 5 inside the inner membrane 1 to maintain the inner membrane 1 in an expanded state. In this state, gas overflowing from the inner space 5 is then discharged through the gas outlet 14, whereby the pressure in the inner space 5 may readily be maintained during the structure forming step after the inner membrane 1 is put up. Therefore, according to this modified example, the shape of the final structure 12 to be constructed can be stabilized.

### 8. Fourth Modified Example of the Present Embodiment

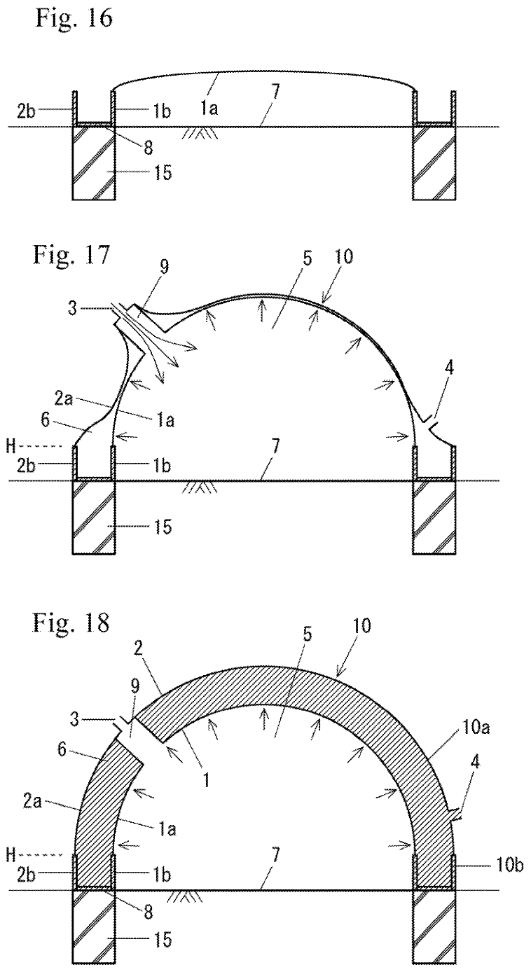

In this modified example, at least one of the inner membrane 1 and the outer membrane 2 comprises upper formworks 1a and 2a using a flexible sheet material, and lower formworks 1b and 2b using a sheet material or plate material (hereinafter referred to as a “rigid material”) that is stiffer than the upper formworks 1a and 2a. In this modified example, each of the inner membrane 1 and the outer membrane 2 comprises the upper formworks 1a and 2a and the lower formworks 1b and 2b as shown in FIGS. 16 to 18. The lower formwork 1b of the inner membrane 1 and the lower formwork 2b of the outer membrane 2 are each fixed to the foundation 15.

Note that only the outer membrane 2 from the inner membrane 1 and the outer membrane 2 may comprises the lower formworks 1b and 2b using a rigid material. Further, only the inner membrane 1 from the inner membrane 1 and the outer membrane 2 may comprise the lower formworks 1b and 2b using a rigid material.

For the lower formworks 1b and 2b, a plate material such as wood or metal may be used. Further, for the lower formworks 1b and 2b, a bendable plywood (such as bent plywood) capable of being bent in one direction may be used. In the latter case, transportation is facilitated because it can be transported in a rolled-up state. Note that the flexible sheet materials 1, 2 and 7 described above are the materials that can be flexibly bent in either of a vertical or horizontal direction and do not include a bendable plywood that can be bent in one direction. The flexible sheet materials 1, 2 and 7 can be folded with a curvature radius of 50 mm or less at the folding points.

In this modified example, the formwork 10 comprises a hemispherical portion 10a composed of the upper formworks 1a and 2a, and a cylindrical portion 10b composed of the lower formworks 1b and 2b (see FIG. 18). The upper formworks 1a and 2a define an upper space from a height H in the structure space 6. The lower formworks 1b and 2b define a lower space from the aforementioned height H in the structural space 6. Here, the lower side of the formwork 10 is likely to bulge during the structure forming step due to the pressure of the structure resin material 13. Compared to the inner membrane 1, which is subjected to the pressure in the inner space 5 (a pressure higher than the atmospheric pressure), the outer membrane 2 is particularly prone to bulge. Therefore, as the height dimension of the formwork 10 increases, there is a risk that the lower portion of the structure 12 would bulge. Especially, there is a risk that the outer surface of the lower portion of the structure 12 would bulge.

In contrast, in this modified example, the use of a rigid material for the lower formworks 1b and 2b enhances the shape stability and dimensional stability of the lower portion of the structure 12. Note that in the case of using the rigid material for the respective lower formworks 1b and 2b of the inner membrane 1 and the outer membrane 2, the lower formwork 1b of the inner membrane 1 and the lower formwork 2b of the outer membrane 2 may be connected and fixed to each other via connecting members 8 made of a rigid sheet material or plate material. Thereby, the need for temporary installation, measuring the distance between the inner membrane 1 and the outer membrane 2 at the construction site is eliminated so that temporary installation of the formwork 10 is facilitated.

In the building of the formwork 10 of this modified example, as shown in FIG. 16, for example, the upper formwork 1a and the lower formwork 1b of the inner membrane 1 and the lower formwork 2b of the outer membrane 2 are temporarily installed. Then, after building the inner membrane 1 of the formwork 10 by filling gas into the gas-filling space 5, the upper formwork 2a is attached to the lower formwork 2b of the outer membrane 2 as shown in FIG. 17. Note that the upper formwork 2a may also be attached to the lower formwork 2b of the outer membrane 2 before building the inner membrane 1.

### 9. Other Modified Examples

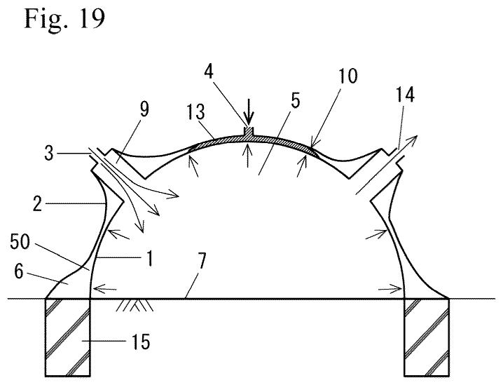

In the above embodiment, the resin inlet 4 is provided to the bottom side of the formwork 10. However, as shown in FIG. 19, the resin inlet 4 may also be provided to the ceiling side. During the structure forming step, the structure resin material 13 is injected into the structure space 6 through the resin inlet 4 provided to the ceiling side of the living space. In this case, the structure resin material 13 can readily be spread over a wide range in the structure space 6 by allowing the structure resin material 13 to flow downward by gravity.

In the above embodiment, the inner membrane 1 and the outer membrane 2 are removed during the finishing step. However, the finishing step may also be performed with the inner membrane 1 and the outer membrane 2 left in place.

In the above embodiment, the structure resin material 13 is injected into the structure space 6 when there is substantially no gas in the structure space 6. However, if gas is present in the structure space 6 at the start of the resin injection step, after sucking out the gas in the structure space 6 using a pump, the structural resin material 13 may be injected into the structure space 6.

In the above embodiment, the building 11 may have a shape other than a dome-shape (for example, arch-shape). If the shape of the building 11 has a wall to be formed flat like an arch-shape, a rigid material may be used for the formwork of the wall and a flexible sheet material may be used for the formwork of the curved face. Specifically, if the shape of the building 11 is arch-shaped, a rigid material may be used for the formwork of the wall faces at both ends, and a flexible sheet material may be used for the formwork of the roof to be curved.

### Reference Embodiment

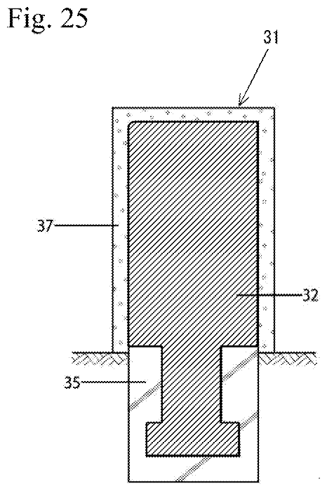

The present reference embodiment is a construction method for constructing a wall 31 (see FIG. 25) as a building (hereinafter referred to as the “construction method of the reference embodiment”).

A formwork 31 of the present reference embodiment, like the formwork 10 of the above-described embodiment, comprises a flexible sheet material 30. The formwork 10 is provided with a structure space 26 that is defined by a sheet material 30 and, when expanded, the structure space 26 assumes a shape corresponding to the shape of a structure 32 (see FIG. 24) of the building 31 (wall) to be constructed. The structure space 26 has a volume in a fully expanded state of, for example, 0.5 m³ or more. The formwork 30 does not have the gas-filling space 5 of the formwork 10 in the above embodiment.

The construction method of the reference embodiment performs a foundation constructing step, a formwork installation step, a resin injection step and a foaming and curing step in this order.

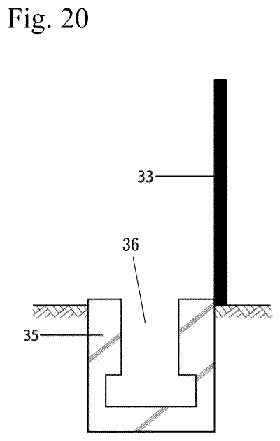

FIG. 20 shows a state after the foundation constructing step is completed. In the present reference embodiment, a space 36 is formed in the foundation 35. During the foundation constructing step, support members 33 supporting the formwork 30 are installed.

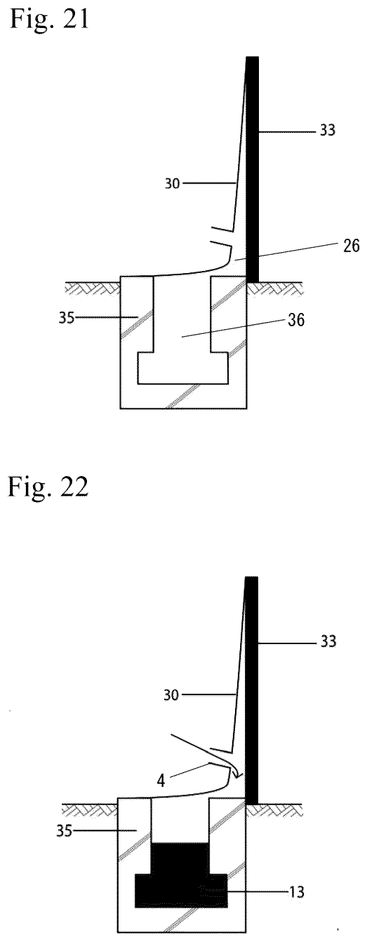

After the foundation constructing step is completed, the formwork installation step is performed. During the formwork installation step, the formwork 30 is installed such that the structure space 26 communicates with the space 36 as shown in FIG. 21.

After the formwork installation step is completed, the resin injection step is performed. During the resin injection step, the structure resin material 13 is injected into the structure space 6 through the resin inlet 4 of the formwork 30 as shown in FIG. 22.

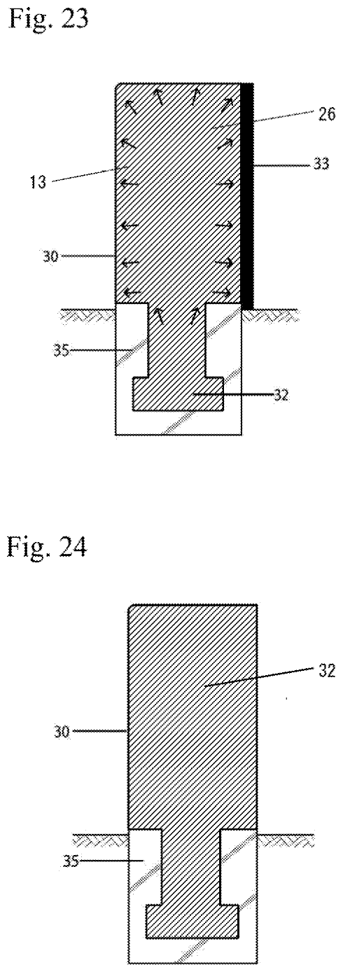

Subsequently, during the foaming and curing step, as shown in FIG. 23, the structure resin material 13 in the structure space 26 is foamed, causing the structure space 26 (formwork 30) to expand. Finally, when the structure space 26 is fully expanded, it assumes a shape corresponding to the shape of the structure 32 of the wall 31 to be constructed. In this reference embodiment, the entire formwork 30 is erected while the structural resin material 13 is being foamed in the structure space 26. Further in the course of the structure resin material 13 being foamed, the support members 33 function as correcting the shape of the formwork 30.

After the structure space 26 is fully expanded, the structure resin material 13 is gradually cured. After a predetermined time lapses, the structure 32 of the wall 31 is completed as shown in FIG. 24. Thereby, the foaming and curing step is completed. The support members 33 are removed after the foaming and curing step is completed.

After the completion of the structure 32, the finishing step is performed to finish the surface of the wall 31. In the finishing step, after the formwork 30 is removed, as shown in FIG. 25, an outermost layer 37 is provided by plastering work and the like to cover the surface of the structure 32.

### <Use of the Present Construction Method and the Like>

The present construction method or the construction method of the reference embodiment may be used as a construction method (foamed material execution methods) for building applications for a building (walls, ceilings, roofs, floors and the like), oil and gas transport/storage tanks, refrigerated/cold storage rooms, plant facilities, earth retaining walls that function as insulation materials, thermal insulation, thermal resistance mitigation materials and the like, foundation structures that function as underground backfill reinforcement materials during ground subsidence prevention work or road construction (structures constructed on-site), structures that function as civil engineering injection repair materials (structures constructed on-site) such as tunnels, bridges or floating piers, structures that function as structural fill materials (structures constructed on-site) in basements and the like and structures used as energy absorption materials, waterproofing materials, water-stopping materials, buoyancy materials and the like. Furthermore, structures such as wooden, reinforced concrete or resin-based structures (for example, columns and the like) may be combined with this construction method or the construction method of the reference embodiment to construct buildings.

### EXAMPLES

Examples of the present disclosure will be described. The present disclosure is not limited to these examples, so long as they do not depart from the essence of the present disclosure.

### <<Resin Composition (Structure Resin Material)>>

### <Raw Materials>

The resin compositions used in Examples 1-3 are shown in Table 1.

TABLE 1

| | Sample Type | Sample Name | Example 1 | Example 2 | Example 3 |
|---|---|---|---|---|---|
| Monomer compound (A) | Isocyanate compound | MR-200 | 50 | 50 | 50 |
| Curing agent, catalyst, | Polyol compound | Maximol RLK-505 | 15 | | |
| radical initiator (B) | Aminic compound | Ethacure 420 | | 15 | |
| | Aminic catalyst | DBU | 1 | 0.3 | |
| Foaming agent | Foaming agent via | Water | | | 15 |
| | reaction with | | | | |
| | isocyanate | | | | |
| | Solvent-based | Fluorinated solvent | 10 | 10 | |
| | foaming agent | with a boiling point | | | |
| | | around 40° C. | | | |
| Foam stabilizer | Silicone compound | SZ 1671 | 1 | 1 | |
| | Nonionic surfactant | YP-1 | | | 5 |
| Flame retardant | Phosphate ester | CR-7 3 3S | 20 | 20 | 20 |
| | flame retardant | | | | |

The following compounds are used as the raw materials in Table 1.
Isocyanate compound: MR-200 (manufactured by Tosoh Corporation)
Polyol compound: Maximol RLK-505 (manufactured by Kawasaki Kasei Industries)
Polyamine compound: Ethacure 420 (manufactured by Albemarle Corporation)
Aminic catalyst: DBU (Diazabicycloundecane)
Silicone compound: VORASURF SZ1671 (manufactured by Dow Toray Co., Ltd.)
Nonionic surfactant: YP-1 (manufactured by Yamagata Chemical Co., Ltd.)
Phosphate ester flame retardant: CR-733S (manufactured by Daihachi Chemical Co., Ltd.)

A preparation method for the nonionic surfactant polyurea YP-1 described above will be described. 5 g of Stabio PDI (manufactured by Mitsui Chemicals, Inc) and 5 g of Ethacure 420 (manufactured by Albemarle Corporatio) were mixed, heated to 60° C. and stirred for 1 hour. 32 g of JEFFAMINE D-2000 (manufactured by Huntsman Performance Products) was added thereto, heated to 60° C. and stirred for 1 hour to obtain 42 g of polyurea YP-1. The weight-average molecular weight of the polyurea YP-1, measured by gel permeation chromatography (converted to standard polystyrene) was 200,000.

### <Preparation of Foam>

### (Preparation of Foam for Each Evaluation)

With respect to the monomer compound (A), the foaming agent (Example 3 only), the foam stabilizer and the flame retardant, the content of each component specified in Table 1 for each example were weighed. The mixture was heated to 30-80° C. and stirred for 5-60 minutes to dissolve the solids into the liquid components, thereby obtaining the mixture liquid (I) for each example.

With respect to the curing agent, the catalyst and the foaming agent (only in Examples 1 and 2), the content of each component specified for each example were weighed. The mixture was heated to 20-50° C., stirred for 5-60 minutes, thereby obtaining the mixture liquid (II) for each example.

The mixture liquid (I) was heated to 20-80° C. Each mixture liquid was sent by a pump and mixed in a mixer. The mixture liquid (II) was mixed with the mixture liquid (I). The mixture liquid was received in a 500 mL polypropylene disposable cup. After foaming and resin-curing, each foam was left at room temperature for one week to obtain each foam.

In addition, filling into the formwork was performed by mixing using a pump and a mixer, followed by filling using the pump. In all examples, the resin composition was foamed and cured in the formwork, whereby a structure having a shape as designed was obtained. Table 2 shows the test results for each example. All structures exhibited a compressive modulus of elasticity of 4 MPa or higher, demonstrating sufficient hardness.

TABLE 2

| | Unit | Example 1 | Example 2 | Example 3 |
|---|---|---|---|---|
| Pre-foaming | kg/m³ | 1260 | 1260 | 1260 |
| density | | | | |
| Apparent density | kg/m³ | 38 | 53 | 50 |
| of foam | | | | |
| Expansion ratio | | 33.2 | 23.8 | 25.3 |
| Compressive | Mpa | 12.5 | 15.4 | 8.2 |
| elastic modulus | | | | |
| Foam hardness | | ◯ | ◯ | ◯ |
| evaluation | | | | |

### INDUSTRIAL APPLICABILITY

The present disclosure is applicable to methods for constructing a building using a foamed resin as a structure material, and the like.

### DESCRIPTION OF REFERENCE CHARACTERS

1 Inner membrane (sheet material)
2 Outer membrane (sheet material)
3 Gas inlet
4 Resin inlet
5 Gas-filling space, inner space
6 Structure space
7 Sheet material
10 Formwork
11 Building, architecture
12 Structure
13 Structure resin material, resin composition containing foaming agent

1. A method for constructing a building, the method comprising:
a formwork installation step of installing a formwork that has a flexible sheet material and is provided with a structure space that is defined by the flexible sheet material, the structure space being configured to form a shape corresponding to a structure shape of the building to be constructed when the structure space is expanded; and
a structure forming step of forming the structure of the building made of a foamed resin by foaming a resin composition containing a foaming agent in the structure space and curing the foamed resin composition in the structure space while the structure space is in an expanded state,
wherein the formwork comprises an inner membrane and an outer membrane as the flexible sheet material, and the structure space is provided between the inner membrane and the outer membrane;
wherein, in the formwork installation step, the inner membrane of the formwork is put up by filling an inner space inside the inner membrane with gas; and
wherein the structure forming step is performed with the inner membrane being put up.

2. The method for constructing a building according to claim 1, wherein the formwork further comprises an intermediate membrane provided between the inner membrane and the outer membrane; and
wherein the intermediate membrane defines the structure space from an indoor side, and the inner membrane supports the intermediate membrane from the indoor side, or
wherein the intermediate membrane defines the structure space from an outdoor side, and the outer membrane supports the intermediate membrane from the outdoor side.

3. The method for constructing a building according to claim 1, wherein, in the structure forming step, the structure space is expanded by starting to foam the resin composition when the structure space is in a shrunk state.

4. The method for constructing a building according to claim 1, wherein a breathable sheet material is not used for the inner membrane.

5. The method for constructing a building according to claim 1, wherein the outer membrane is provided with a ventilating portion configured to release air from the structure space.

6. The method for constructing a building according to claim 5, wherein the flexible sheet material is a breathable mesh sheet, and the ventilating portion is gaps between threads of the mesh sheet.

7. The method for constructing a building according to claim 5, wherein the flexible sheet material is a breathable nonwoven sheet with entangled fibers, and the ventilating portion is gaps between the fibers of the nonwoven sheet.

8. The method for constructing a building according to claim 1,
wherein the formwork is provided with a gas inlet and a gas outlet;
wherein, with the inner membrane being put up, gas is continuously supplied from the gas inlet into an inner space inside the inner membrane to inflate the inner space; and
wherein gas overflowing from the inner space under this state is discharged through the gas outlet.

9. A method for constructing a building according to claim 1,
wherein the building has a living space; and
wherein, in the structure forming step, the resin composition is injected into the structure space through a resin inlet provided in a ceiling side of the living space of the formwork.

10. The method for constructing a building according to claim 1, wherein, in the structure forming step, after sucking out gas in the structure space by a pump, the resin composition is injected into the structure space through the resin inlet.

11. The method for constructing a building according to claim 1, wherein a support pillar is provided to support the inner membrane from the indoor side before or after the formwork installation step.

12. The method for constructing a building according to claim 1, wherein at least one of the inner membrane and the outer membrane comprises an upper formwork using the flexible sheet material and a lower formwork using a sheet material or plate material stiffer than that of the upper formwork.

13. A formwork for constructing a building,
comprising a flexible sheet material,
wherein the formwork is provided with a structure space that is defined by the flexible sheet material and, the structure space being configured to form a shape corresponding to a structure shape of the building to be constructed when the structure space is expanded;
wherein the formwork is configured such that the structure of the building made of a foamed resin is formed by foaming a resin composition containing a foaming agent in the structure space and curing the foamed resin composition in the structure space with the structure space being expanded;
wherein the formwork comprises an inner membrane and an outer membrane as the sheet material, and the structure space is provided between the inner membrane and the outer membrane; and
wherein a breathable sheet material is not used for the inner membrane.

14. A formwork for constructing a building,
comprising a flexible sheet material,
wherein the formwork is provided with a structure space that is defined by the flexible sheet material and, the structure space being configured to form a shape corresponding to a structure shape of the building to be constructed when the structure space is expanded;
wherein the formwork is configured such that the structure of the building made of a foamed resin is formed by foaming a resin composition containing a foaming agent in the structure space and curing the foamed resin composition in the structure space with the structure space being expanded;
wherein the formwork comprises an inner membrane and an outer membrane as the sheet material, and the structure space is provided between the inner membrane and the outer membrane; and
wherein the outer membrane is provided with a ventilating portion for releasing air from the structure space.
